(19) United States
(12) Patent Application Publication
(10) Pub. No.: US 2005/0189284 A1
(43) Pub. Date: Sep. 1, 2005

(54) Removable sieve device for a dry food dispenser

(76) Inventor: Paul Burfield, Crawley (GB)

Correspondence Address: BAY AREA INTELLECTUAL PROPERTY GROUP, LLC, PO BOX 210459, SAN FRANCISCO, CA, 94121-0459, US

(21) Appl. No.: 11/064,802

(22) Filed: Feb. 24, 2005

(30) Foreign Application Priority Data
Feb. 27, 2004 (GB) 0404362.6

(51) Int. Cl. A23L 1/216

(52) U.S. Cl. 210/369

(57) ABSTRACT

The purpose of this invention is to provide a removable sieve for dry food (e.g., cereal) dispensers, so that during use of the dispenser, the smaller particles are sifted from the larger granules. These smaller particles are trapped behind a barrier upon dispensing, so that they are not delivered within the bulk of the cereal or dry food. After emptying the dispenser, the removable sieve can be easily removed to discard the unwanted particles.

### CROSS-REFERENCE TO RELATED APPLICATIONS

The present Utility patent application claims priority to the Great Britain patent application number 0404362.6 filed on Feb. 27, 2004.

### FIELD OF THE INVENTION

The present invention relates generally to reusable type dry food dispensers. More particularly, the invention relates to reusable dry food (e.g., cereals) dispensers that are capable of sifting out smaller particles from the larger granules.

### BACKGROUND OF THE INVENTION

Many containers exist for the convenient storage and dispensing of dry foods. Several kinds of dry foods contain smaller particles that are undesirable to be dispensed for consumption. One of the most common examples are cereals, which will be described below as a representative example.

By way of example, to retain freshness over relatively long periods, the consumer may transfer breakfast cereal from the manufacturer's original packaging into a ‘reusable’ type cereal dispenser. Cereal dispensers are well known, but typically suffer from the disadvantage that, when they are replenished with cereal, powdery cereal particles are transferred from the original cereal container into the cereal dispenser. Furthermore, particles are also created in daily use of the dispenser as the cereal granules rub against each other and so cause small particles to break off. This build up of powdery cereal is especially evident when the consumer pours the last servings from the dispenser. Often, these small particles are undesirable, and may not be to the consumers liking, and thereby detract from the quality and consumer's perception of the product.

Attempts have been made to resolve the foregoing problem. Some examples of known solutions are described in U.S. Pat. No. 4,889,619 and U.S. Pat. No. 5,958,483.

U.S. Pat. No. 4,889,619 describe a sieve member which is integrally attached to the side walls of a cereal container. Unfortunately, in practice, this arrangement is typically impractical for a number of reasons, a couple of which will be set forth. Firstly, the sieve is not readily removable and is, thereby, more appropriate to be incorporated into the original manufacturer's packaging. Secondly, the sieve member is located across the base of the container and as such does not utilize the movement of the cereal to assist in sifting while the consumer is serving the dry food product.

U.S. Pat. No. 5,958,483 disclose a ‘double bagged’ package, wherein the inner bag is perforated and the outer bag serves to collect debris filtered from the inner bag. This arrangement is similarly more appropriately incorporated into the original manufacturers packaging and is not practical for use in a ‘reusable’ type cereal dispenser. Moreover, as with the prior example, the base location of the sieve member is inefficient for sifting.

In view of the foregoing, there is a need for improved techniques for sifting out smaller particles from the larger granules that are dispensed from a dry food container. It would be desirable if a technique existed that sifted out the smaller particles from the dispensed dry food during, and throughout, the dispensing process. It would be further desirable if these smaller particles were trapped behind a barrier upon serving, so that they are not delivered within the bulk of the cereal.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an Isometric view of an exemplary removable sieve, in accordance with an embodiment of the present invention;

FIG. 2 shows a cross sectional view of the exemplary sieve of FIG. 1 placed inside a typical cereal dispenser; and

FIG. 3 depicts a partial cutaway view of the example of FIG. 2 in use, as viewed from below the serving position.

Unless otherwise indicated illustrations in the figures are not necessarily drawn to scale.

### SUMMARY OF THE INVENTION

To achieve the forgoing and other objects and in accordance with the purpose of the invention, a variety of removable sieve devices for dry food dispensers are described.

An embodiment of the present invention introduces a removable sieve member applied to the ‘reusable’ type dry food or cereal dispensers. The removable sieve member is provided with a plurality of holes for sifting out small particles in the dispenser contents. Another aspect of the present invention improves the effectiveness of the sifting. In an embodiment, this is achieved by locating the main sieve member about the inner surface or surfaces of the cereal dispenser adjacent to the pouring spout.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

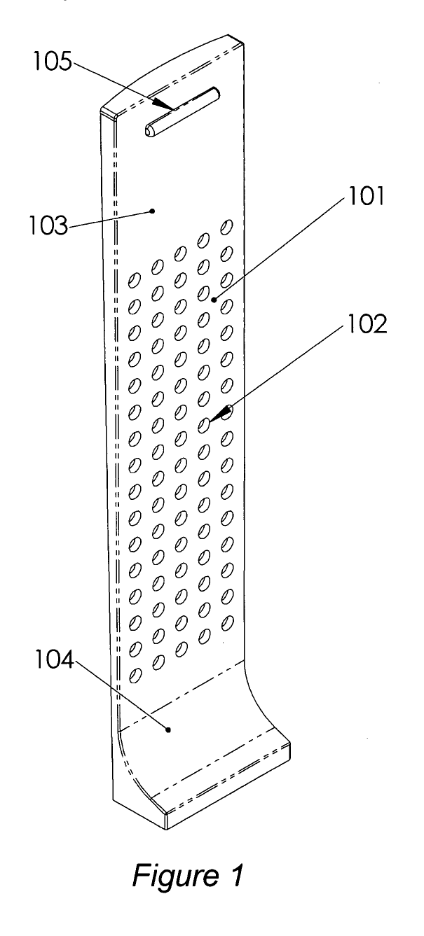

FIG. 1 shows an Isometric view of an exemplary removable sieve, in accordance with an embodiment of the present invention. As shown in the Figure, the removable sieve comprises of a particle barrier 101 with a multiplicity sifting holes 102 of a pre-determined size within its form. In the preferred embodiment, sifting holes 102 are not located within end portions 103 and 104. Those skilled in the art will readily recognize the best size and distribution of the sifting holes to achieve optimal sifting efficiency for the particular application.

The outer periphery of particle barrier 101 is preferably contoured to be close fitting with the inside contour of the cereal dispenser. An optional finger grip feature may be incorporated as shown by way of example by a raised lip 105, which may be provided to assist the removal of the removable sieve from the cereal dispenser. However, alternative embodiments may not include the raised lip, or may configure it instead as a gripping depression, gripping textured surface, or any suitable gripping means known to those skilled in the art.

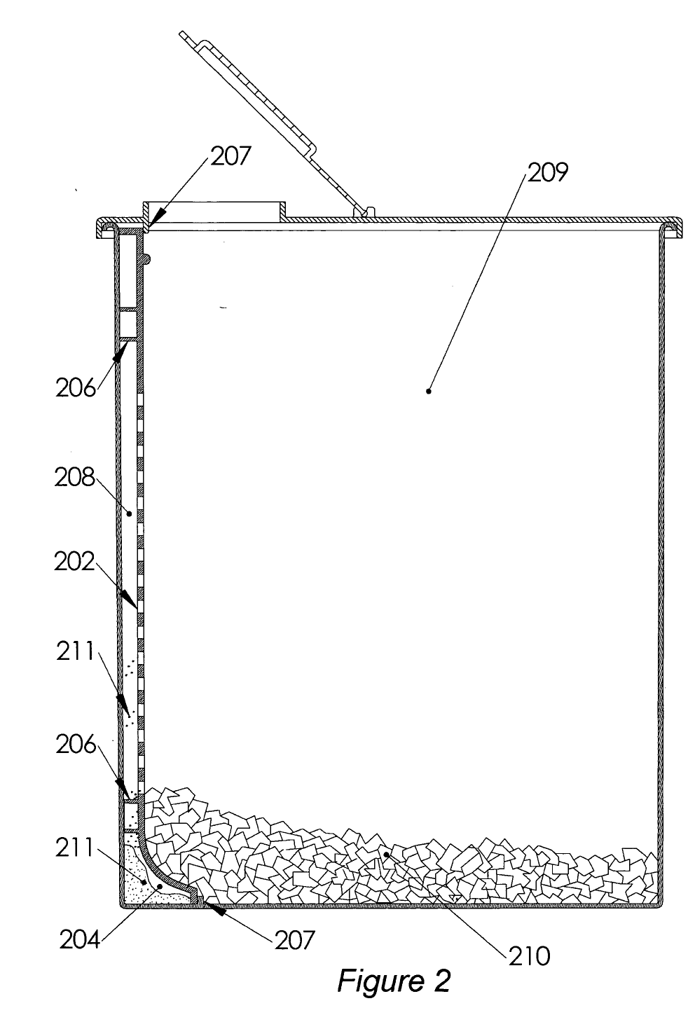

FIG. 2 illustrates a cross sectional view of the exemplary sieve of FIG. 1 placed inside a typical cereal dispenser. The cereal dispenser shown comprises a main compartment 209, and a cereal 210. As shown in the Figure, an exemplary approach for spacing the removable sieve member away from the wall of the cereal dispenser is provided by standoff 206, and thereby inherently creates a separate compartment 208 for the sifted particles to fall into. Any suitable means known to those skilled in the art to standoff the present sieve from the cereal box may be implemented. An exemplary approach for retaining the present removable sieve inside the cereal dispenser is provided by a retaining rib(s) 207. As will be appreciated by those skilled in the art, the retaining rib(s) may be implemented in any suitable manner for the particular application, wherein the retaining rib approach that is actually implemented may be part of the cereal dispenser or integral with the present removable sieve. By way of further example, and not limitation, some applications (not shown) may only include an upper or lower retaining rib, but not both (as shown).

During typical use, when main compartment 209 contains cereal 210 and the cereal dispenser is tilted for pouring, smaller particles 211 of a size smaller than the predetermined size of sifting holes 202 will fall into a collection compartment 208, which is inherently formed between the cereal container wall and particle barrier 101. When the cereal dispenser is returned into an upright position, sifted particles 211 fall, through an opening in the lower standoff 206, into an enclosed area behind a sealed area 204 (which is devoid of sifting holes 202) so that they are not reintroduced into the main compartment 209. Standoff 206 may be implemented in any suitable manner known to those skilled in the art such that they provide an adequate volume in collection compartment 208 and allow an adequate flow of smaller particles 211 into sealed area 204 during typical use the particular application.

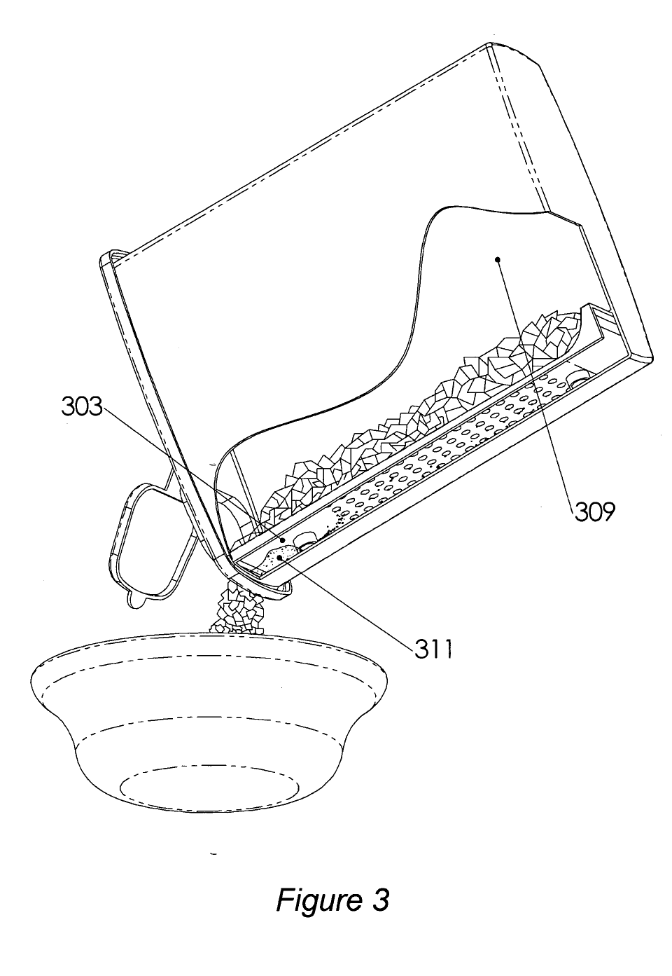

FIG. 3 illustrates a partial cutaway view of the example of FIG. 2 in typical use, as viewed from below the serving position, thereby revealing the operational details of the present removable sieve embodiment. As shown in the Figure, upon dispensing the cereal from the dispenser, it can be seen that small particles 311 are substantially trapped behind sealed area 303 such that they are substantially prevented from reentering the bulk of the cereal in main compartment 309 while pouring and upon later righting the cereal container.

The removable sieve located in this position takes advantage of the movement of the cereal across the sieving apertures on pouring the cereal from the dispenser. Sifting is further improved in this location by utilizing the user's instinctive motion of shaking the dispenser during this action of pouring. This action agitates the smaller particles to migrate towards the removable sieve member.

After emptying the cereal dispenser, the removable sieve can be easily removed to discard the unwanted cereal particles and also ease cleaning of the removable sieve and the cereal dispenser.

To suit the differing varieties of cereals available, one, two or several sieve inserts may be provided with a range sieve aperture sizes.

The removable sieve may be of a rectangular form to suit the traditional shaped cereal dispensers, or it may be for example, tubular, for insertion into a cylindrical dispenser. The novelty aspect is its location about the inner surface or surfaces adjacent to the pouring spout.

Removable sieve embodiments of the present invention may be manufactured according to principles known to those skilled in the art (e.g., injection molding) and made of any suitable material, including but not limited to a metal, a plastics material, or from a combination of these materials.

Having fully described at least one embodiment of the present invention, other equivalent or alternative methods of providing a removable sieve device for a dry food dispenser according to the present invention will be apparent to those skilled in the art. The invention has been described above by way of illustration, and the specific embodiments disclosed are not intended to limit the invention to the particular forms disclosed. For example, it should be appreciated that the foregoing detailed description is directed towards cereal application for the sake of clarity, and that those skilled in the art will readily recognize how to apply the teachings of the present invention to a multiplicity of suitable dispensing application, whereby such alternative implementations of the present invention are contemplated as within the scope of the present invention. The invention is thus to cover all modifications, equivalents, and alternatives falling within the spirit and scope of the following claims.

1. A removable sieve for a cereal dispenser, comprising:
a barrier, said barrier being configured to cover an inner surface of the cereal dispenser that receives a portion of the cereal contents when dispensing the cereal out of the cereal dispenser, said barrier being further configured with a plurality of holes disposed within a midsection of said barrier;
a standoff for maintaining a minimum collection compartment volume between said barrier and the inner surface of the cereal dispenser.

2. The removable sieve of claim 1, wherein the outer periphery of said barrier is contoured to be close fitting with the inside contour of the cereal dispenser.

3. The removable sieve of claim 1, wherein said barrier has a solid, lower end portion devoid of said holes, said solid end portion being useful for trapping the sifted smaller particles upon dispensing the cereal.

4. The removable sieve of claim 1, further comprising a finger gripping means for facilitating the removal of said removable sieve by a finger.

5. The removable sieve of claim 1, wherein said removable sieve is made from a metal, a plastics material, or from a combination of these materials.

6. A removable sieve for a dry food dispenser, comprising:
a barrier, said barrier being configured to cover an inner surface of the dry food dispenser that receives a portion of the dry food contents when dispensing the dry food out of the dry food dispenser, said barrier being further configured with a plurality of holes disposed within a midsection of said barrier;
a standoff for maintaining a minimum collection compartment volume between said barrier and the inner surface of the dry food dispenser.

7. The removable sieve of claim 6, wherein the outer periphery of said barrier is contoured to be close fitting with the inside contour of the dry food dispenser.

8. The removable sieve of claim 6, wherein said barrier has a solid, lower end portion devoid of said holes, said solid end portion being useful for trapping the sifted smaller particles upon dispensing the dry food.

9. The removable sieve of claim 6, further comprising a finger gripping means for facilitating the removal of said removable sieve by a finger.

10. The removable sieve of claim 6, wherein said removable sieve is made from a metal, a plastics material, or from a combination of these materials.

11. A removable sieve for a dry food dispenser, comprising:
barrier means for blocking large dry food pieces from passing through said barrier means;
means for sifting small particles in the dry food, thereby permitting the small particles to pass through said barrier means;
means for creating a minimum collection compartment volume between said barrier means and the inner surface of the dry food dispenser; and
means for trapping the sifted smaller particles upon dispensing the dry food.
